(19) United States
(12) Patent Application Publication
(10) Pub. No.: US 2005/0108397 A1
(43) Pub. Date: May 19, 2005

(54) Reducing number of messages processed by control processor by bundling control and data messages and offloading the TCP connection setup and termination messages

(75) Inventors: Claude Basso, Raleigh, NC (US); Philippe Damon, Raleigh, NC (US); Stephen M. Fontes, Morrisville, NC (US); Colin B. Verrilli, Apex, NC (US)

Correspondence Address: KELLY K. KORDZIK;WINSTEAD SECHREST & MINICK PC, PO BOX 50784, DALLAS, TX, 75201, US

(73) Assignee: International Business Machines Corporation, Armonk, NY (US)

(21) Appl. No.: 10/713,343

(22) Filed: Nov. 14, 2003

(51) Int. Cl. G06F 15/16; G06F 15/173

(52) U.S. Cl. 709/225; 709/237

(57) ABSTRACT

A method, computer program product and system for reducing the number of messages to be processed by a control processor in a load balancer. A network processor instead of the control processor in the load balancer may establish and terminate a TCP connection between a client and the load balancer and between the load balancer and a server. Further, messages, e.g., data and control messages, may be bundled into a single message to be transmitted between the network processor and the control processor. By bundling messages into a single message as well as offloading the establishment and termination of TCP connections to the network processor instead of the control processor, the number of messages to be processed by the control processor is reduced. Consequently, the performance of the load balancer is improved.

### TECHNICAL FIELD

The present invention relates to the field of computerized distribution information systems, and more particularly to reducing the number of messages processed by a control processor in a load balancer by bundling control and data messages and offloading the TCP connection setup and termination messages.

### BACKGROUND INFORMATION

The development of computerized distribution information systems, such as the Internet, allows users to link with servers and networks, and thus retrieve vast amounts of electronic information that was previously unavailable using conventional electronic mediums. Such electronic information increasingly is replacing the more conventional means of information such as newspapers, magazines and television.

The Internet is based upon a suite of communication protocols known as Transmission Control Protocol/Internet Protocol (TCP/IP) which sends packets of data between a server (commonly referred to as a web server) and a client machine, e.g., a user's computer connected to the Internet.

Due to the increasing traffic over computer networks such as the Internet, data providers must satisfy an increasing number of data requests from clients. For example, a company that provides a search engine for the Internet may handle over a million hits, i.e., accesses to its web page, every day. A single server cannot handle such a large volume of data requests within an acceptable response time. Therefore, most high-volume information providers use multiple servers, commonly referred to as a server farm, to satisfy the large number of data requests.

To maximize the benefits of having multiple servers, data providers should spread the data requests to the servers in the server farm so that the load on each server is roughly equal. This may be accomplished by a device, referred to as a “load balancer.” The load balancer may distribute incoming requests from clients to be serviced by selected servers in the server farm so that the load on each server is roughly equal.

A load balancer may include a processor, referred to as a “network processor,” which is configured to process packets commonly referred to as “fast path packets.” Fast path packets may refer to packets that can be processed using limited resources (instructions, memory) of the network processor.

A load balancer may further include a processor, referred to as a “control processor.” The control processor may be configured to manage the overall operation of the load balancer. For example, the control processor may initialize the network processor, download boot or diagnostic code and install operational code on the network processor. Furthermore, the control processor may be configured to process packets that are commonly referred to as “slow path packets” which require more complicated operations than fast path packets. Slow path packets may refer to packets that are redirected from the network processor to the control processor to be processed by the control processor. For example, slow path packets may include packets that cannot be handled by the network processor, e.g., Internet Protocol (IP) packets with options, packet implementing Border Gateway Protocol (BGP) routing protocol, packet implementing Open Shortest Path First (OSPF) routing protocol. In the case of a load balancer application, slow path packets may also include connection setup and connection closing packets, e.g. TCP SYN and FIN packets.

As stated above, the Internet is based upon a suite of communication protocols known as TCP/IP. In TCP/IP, the standard describes how an Internet-connected computer should break data down into packets for transmission across the network, and how those packets should be addressed so that they arrive at their destination. IP is the connectionless part of the TCP/IP protocol. The TCP specifies how two Internet computers can establish a reliable data link by means of handshaking.

When a client requests to establish a TCP connection with a server, the request may be handled by the load balancer which acts as a proxy for the server. The request to establish a TCP connection may involve a three message handshake between the load balancer and the client. In particular, the client may issue a SYN packet to the network processor in the load balancer. The network processor may then forward the SYN packet to the control processor in the load balancer. The control processor may then issue a SYN/ACK packet to the client. The client, in turn, may issue an ACK packet to the network processor which may then be forwarded to the control processor.

After the TCP connection is established, the client may issue its request, e.g., HyperText Transport Protocol (HTTP) request, to access a web site maintained by one or more servers. The HTTP request may include a Uniform Resource Locator (URL) to identify a particular web site. This request may be received by the network processor which may be forwarded to the control processor. The control processor may extract pertinent information, e.g., source Internet Protocol (IP) address, destination IP address, source Transmission Control Protocol (TCP) port number, destination TCP port number, from the header of the request as well as the URL from the HTTP portion of the request in order to select the appropriate server in the server farm to service the request. Upon selecting the appropriate server in the server farm, the control process may establish a TCP connection with the selected server using the above-outlined three message handshake.

The control processor may then issue a message to the network processor that includes information to enable the network processor to create two new entries in the forwarding table (table that is used by the network processor to determine where to forward the packet received) for the connection between the load balancer and the selected server and the connection between the client and the load balancer. By creating these entries in the forwarding table, the future packets from this client are forwarded to the server selected by the control processor until the TCP connection is terminated. The network processor may issue a confirmation to the control processor upon receipt of this message. Messages between the control processor and the network processor that do not involve forwarding any information from a network device may be referred to as “control messages.” Other types of messages, e.g., messages involved in establishing or terminating a TCP connection, requests and responses, may be referred to as “data messages.”

The control processor may then forward the client's request to the server to be serviced. The response from the server may be issued directly to the network processor which may then perform a table lookup (lookup in the forwarding table) to identify the correct client to forward the server's response by indexing in the forwarding table using information in the header of the server's response. After the network processor transmits the server's response to the correct client, the network processor may receive an acknowledgment from the client. The network processor may then perform a table lookup (lookup in the forwarding table) to identify the correct server to service the client's response by indexing in the forwarding table using information in the header of the client's response. The client and the server: may continue to respond to each other's messages until the server terminates the TCP connection. During this period, the network processor handles the exchange of packets while the control processor is not involved.

The server may initiate the termination of the TCP connection via a three message handshake between the server and the client with the control processor acting at as an intermediary between the server and the client. After the termination of the TCP connection, the control processor may issue a control message to the network processor to delete the entries in the forwarding table relating to the two connections (connection between the load balancer and the server and the connection between the client and the load balancer) that were terminated.

Using the above process to establish and terminate a TCP connection may involve the control processor processing at least 16 messages. Each message processed by the control processor involves a large number of processing cycles. If the number of messages to be processed by the control processor could be reduced, the performance of the control processor and hence the performance of the load balancer could be improved.

Therefore, there is a need in the art to reduce the number of messages to be processed by the control processor in connection with the establishment and termination of the TCP connection.

### SUMMARY

The problems outlined above may at least in part be solved in some embodiments by bundling messages, e.g., data and control messages, into a single message to be transmitted between the network processor and the control processor as well as offloading the establishment and termination of TCP connections to the network processor instead of the control processor.

In one embodiment of the present invention, a method for reducing the number of messages to be processed by a control processor in a load balancer may comprise the step of receiving a request to establish a TCP connection from a client by a network processor in the load balancer. The method may further comprise establishing the TCP connection with the client via handshake messages between the network processor and the client. The method may further comprise receiving a request message from the client. The method may further comprise bundling the request message and the handshake messages involved in establishing the, TCP connection by the network processor. The method may further comprise transmitting the bundled message to the control processor by the network processor.

The foregoing has outlined rather generally the features and technical advantages of one or more embodiments of the present invention in order that the detailed description of the invention that follows may be better understood. Additional features and advantages of the invention will be described hereinafter which may form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a network system in accordance with an embodiment of the present invention;

FIG. 2 illustrates an embodiment of the present invention of a load balancer in the network system;

FIG. 3 is a diagram illustrating the flow of data and control messages between a client, a server, a control processor and a network processor in accordance with an embodiment of the present invention; and

FIG. 4 is a flowchart of a method for reducing the number of messages to be processed by the control processor in connection with the establishment and termination of a TCP connection in accordance with an embodiment of the present invention.

### DETAILED DESCRIPTION

The present invention comprises a method, computer program product and system for reducing the number of messages to be processed by a control processor in a load balancer. In one embodiment of the present invention, a network processor instead of the control processor in the load balancer establishes a TCP connection between the client and the load balancer. The network processor may bundle the packets involved in establishing the TCP connection as well as a request, e.g., HTTP request, from the client into a single message that is transmitted to the control processor. The control processor may select a particular server in a server farm to service the client's request using information extracted from the header of the client's request. The control processor may bundle the client's request as well as a control message into a single message where the control message contains information to enable the network processor to create entries in a forwarding table and establish a TCP connection with the selected server. This bundled message may be transmitted to the network processor by the control processor. The network processor may consequently establish a TCP connection with the selected server. Further, the network processor may facilitate the termination of the TCP between the client and the selected server. After the termination of a particular number of TCP connections, the network processor may bundle information regarding a series of closed connections where the bundled information may be transmitted to the control processor to be evaluated. By bundling messages, e.g., data and control messages, into a single message to be transmitted between the network processor and the control processor as well as offloading the establishment and termination of TCP connections to the network processor instead of the control processor, the number of messages to be processed by the control processor is reduced. Consequently, the performance of the load balancer is improved.

Although the present invention is described with reference to the TCP/IP protocol, it is noted that the principles of the present invention may be applied to other communication protocols. It is further noted that embodiments applying the principles of the present invention to other communication protocols, would fall within the scope of the present invention.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

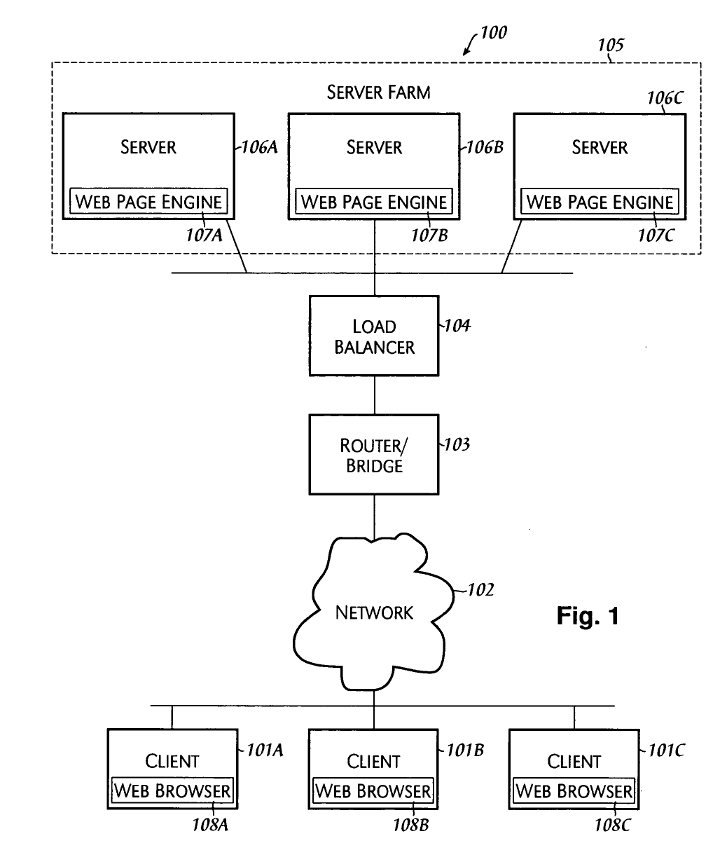

FIG. 1—Network System

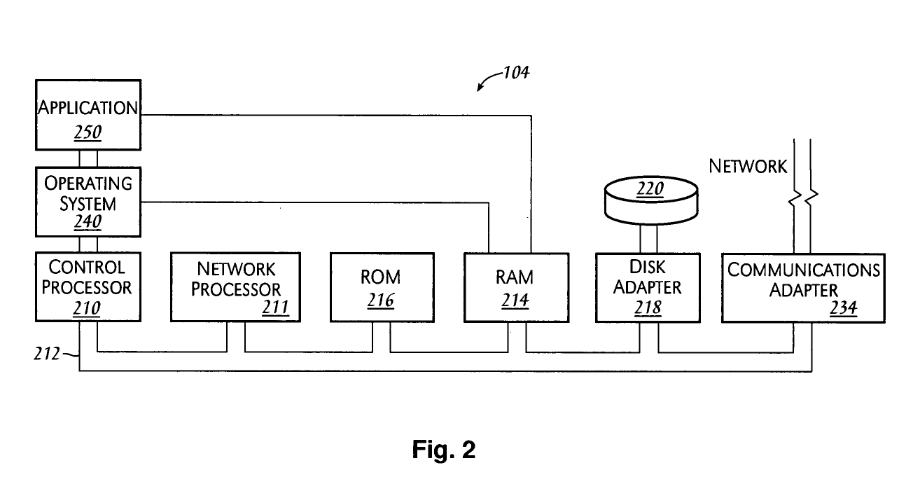

FIG. 1 illustrates an embodiment of a network system 100 in accordance with the present invention. Network system 100 may comprise one or more clients 101A-C coupled to a network 102. Clients 101A-C may collectively or individually be referred to as clients 101 or client 101, respectively. Network 102 may be a Local Area Network (LAN), e.g., Ethernet, Token Ring, ARCnet or a Wide Area Network (WAN), e.g., Internet. In one embodiment, network 102 may be an Internet Protocol (IP) network. Network system 100 may further comprise a router/bridge 103 coupled to network 102. Network system 100 may further comprise a load balancer 104 coupled between a server farm 105 and router/bridge 103. Router/bridge 103 may be configured to forward packets of data from client 101 to load balancer 104. It is noted that router/bridge 103 may be any device that handles communications between networks. Server farm 105 may comprise a plurality of interconnected servers 106A-C configured to host one or more web sites. Servers 106A-C may collectively or individually be referred to as servers 106 or server 106, respectively. Load balancer 104 may be configured to distribute incoming requests from clients 101 to be serviced by selected servers 106 in server farm 105 so that the load on server 106 are roughly equal. A more detail description of load balancer 104 is provided below in association with FIG. 2. It is noted that the connection between client 101 and server 106 may be any medium type, e.g., wireless, wired. It is further noted that client 101 may be any type of device, e.g., wireless, Personal Digital Assistant (PDA), cell phone, personal computer system, workstation, Internet appliance, configured with the capability of connecting to network 102 and consequently communicating with server 106. It is further noted that network system 100 may be any type of system that has a load balancer, a server farm and at least one client and that FIG. 1 is not to be limited in scope to any one particular embodiment.

Referring to FIG. 1, servers 106A-C may each comprise a web page engine 107A-C, respectively. Web page engines 107A-C may collectively or individually be referred to as web page engines 107 or web page engine 107, respectively. Web page engine 107 may be configured to maintain and provide access to an Internet web page which is enabled to forward web pages to a web browser, e.g., web browser 108A, of a client 101. Web pages are typically formatted as a markup language file, for example, HyperText Markup Language (HTML) or Extended Markup Language (XML).

Clients 101A-C may each comprise a web browser 108A-C, respectively. Web browsers 108A-C may collectively or individually be referred to as web browsers 108 or web browser 108, respectively. Web browser 108 may be configured for reading and interpreting web pages. While the illustrated client engine is a web browser 108, those skilled in the art will recognize that other client engines may be used in accordance with the principles of the present invention.

FIG. 2—Load Balancer

FIG. 2 illustrates an embodiment of the present invention of load balancer 104 (FIG. 1). Referring to FIG. 2, load balancer 104 may comprise at least one control processor 210 and at least one network processor 211 coupled to various other components by system bus 212. It is noted that while FIG. 2 illustrates a common system bus 212 that devices, e.g., communications adapter 234 and network processor 211, may be interconnected via dedicated busses. Network processor 211 may be configured to process packets that are commonly referred to as “fast path packets.” Fast path packets may refer to packets, e.g., Internet Protocol (IP) packets, that can be processed using a limited amount of resources. Control processor 210 may be configured to manage the overall operation of load balancer 104. For example, control processor 210 may initialize network processor 211, download boot or diagnostic code and install operational code on network processor 211. Furthermore, control processor 210 may be configured to process packets that are commonly referred to as “slow path packets” which require more complicated operations than fast path packets. Slow path packets may refer to packets that are redirected from network processor 211 to control processor 210 to be processed by control processor 210. For example, slow path packets may include packets that cannot be handled by network processor 211.

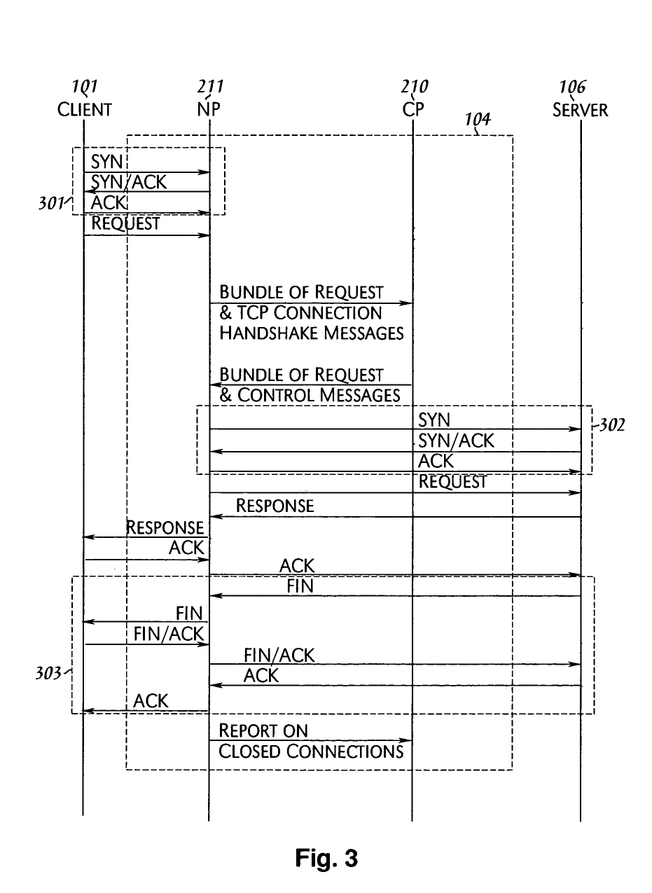

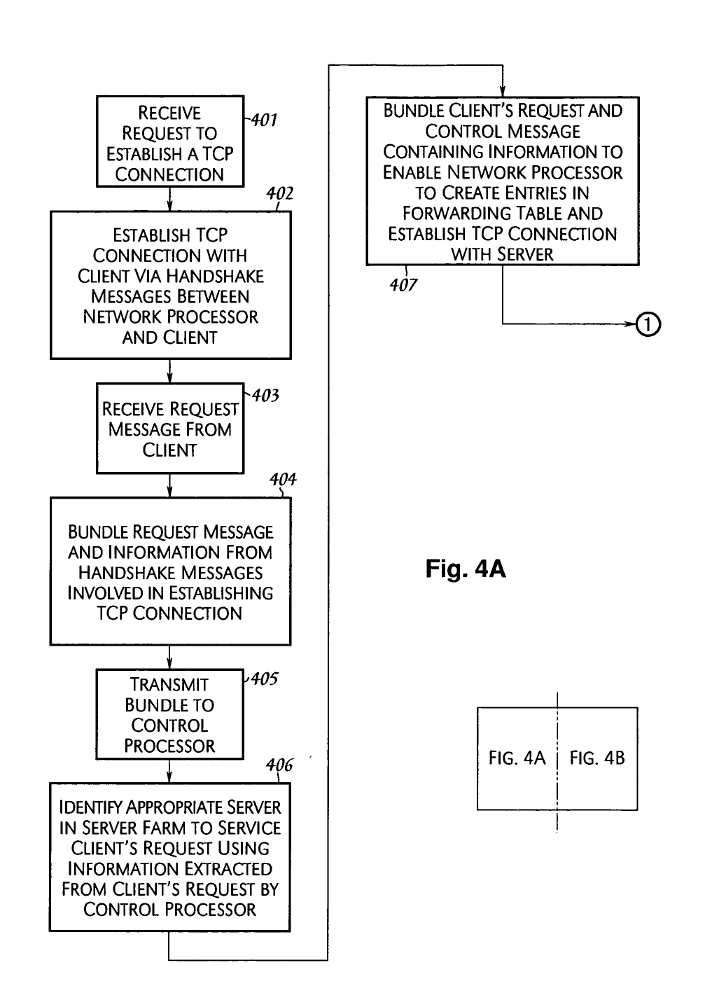

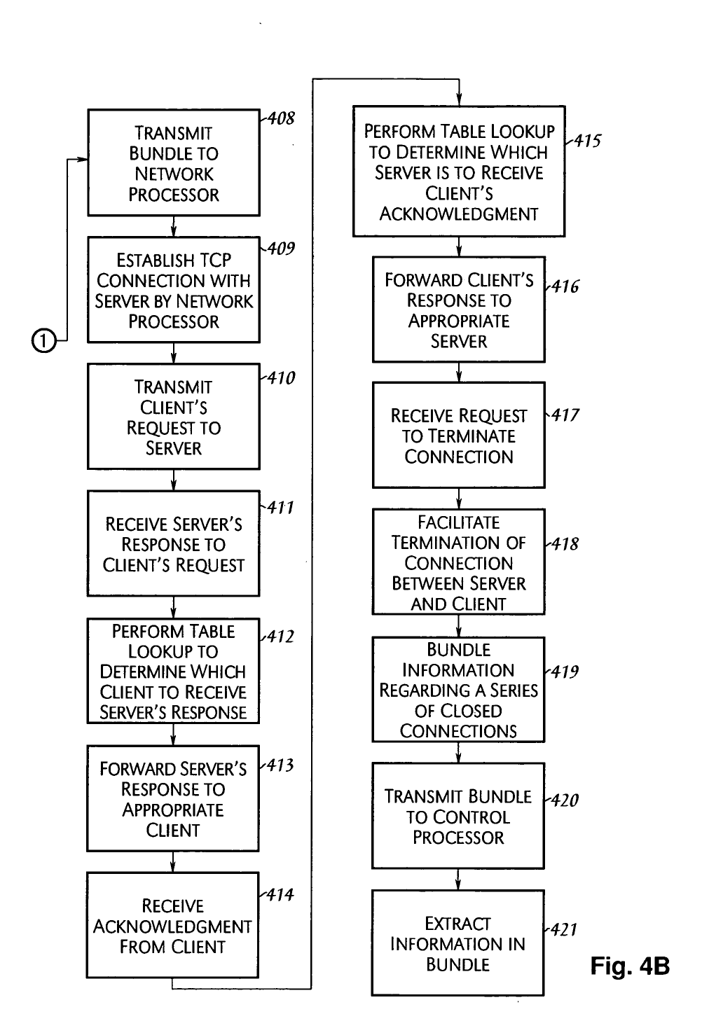

Referring to FIG. 2, an operating system 240, may run on control processor 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Application 250 may include, for example, a program for reducing the number of messages to be processed by control processor 210 in load balancer 104 in connection with the establishment and termination of a TCP connection as described below in association with FIGS. 3 and 4.

Load balancer 104 may further comprise a read-only memory (ROM) 216 coupled to system bus 212 and include a basic input/output system (“BIOS”) that controls certain basic functions of load balancer 104. Random access memory (RAM) 214, disk adapter 218 and communications adapter 234 may also be coupled to system bus 212. It should be noted that software components including operating system 240 and application 250 may be loaded into RAM 214 which may be the load balancer's 104 main memory for execution. RAM 214 may be configured to store a forwarding table configured to contain information used to determine where to forward received packets of data. Disk adapter 218 may be a small computer system interface (“SCSI”) adapter that communicates with a disk unit 220, e.g., disk drive. It is noted that the program of the present invention that reduces the number of messages to be processed by control processor 210 in load balancer 104 in connection with the establishment and termination of a TCP connection, as described below in association with FIGS. 3 and 4, may reside in disk unit 220 or in application 250. It is further noted that the forwarding table configured to contain information used to determine where to forward received packets of data may reside in disk unit 220. Communications adapter 234 may interconnect bus 212 with network 102 enabling load balancer 104 to communicate with client 101 (FIG. 1), server 106 (FIG. 1) or any other network device.

Implementations of embodiments of the present invention include implementations as a computer system programmed to execute the method or methods described herein, and as a computer program product. According to the computer system implementations, sets of instructions for executing the method or methods are resident in the random access memory 214 of one or more computer systems configured generally as described above. Until required by load balancer-. 104, the set of instructions may be stored as a computer program product in another computer memory, for example, in disk drive 220 (which may include a removable memory such as an optical disk or floppy disk for eventual use in disk drive 220). Furthermore, the computer program product can also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

As stated above, the process outlined in the Background Information section to establish and terminate a TCP connection may involve the control processor processing at least 16 messages. If the number of messages to be processed by the control processor could be reduced, the performance of the control processor and hence the performance of the load balancer could be improved. Therefore, there is a need in the art to reduce the number of messages to be processed by the control processor in connection with the establishment and termination of the TCP connection. A process for reducing the number of messages to be processed by the control processor in connection with the establishment and termination of the TCP connection is described below in association with FIGS. 3 and 4. FIG. 3 is a diagram illustrating the flow of data and control messages between client 101, server 106, control processor 210 and network processor 211 involved in the establishment and termination of a TCP connection and transfer of data between server 106 and client 101. FIG. 4 is a flowchart of a method for reducing the number of messages to be processed by control processor 210 in connection with the establishment and termination of the TCP connection. FIGS. 3 and 4 will be discussed in conjunction with one another.

FIGS. 3 and 4—Diagram and Flowchart for Reducing the Number of Messages to be Processed by the Control Processor in Connection with the Establishment and. Termination of the TCP Connection

FIG. 3 is a diagram illustrating the flow of data and control messages between client 101 (FIG. 1), server 106 (FIG. 1), control processor 210 (FIG. 2) and network processor 211 (FIG. 2) involved in the establishment and termination of a TCP connection and transfer of data between server 106 and client 101 in accordance with an embodiment of the present invention. Referring to FIG. 3, messages to and from client 101 are represented by arrows to and from the line entitled “client 101.” Further, messages to and from network processor 211 are represented by arrows to and from the line entitled “NP 211.” Further, messages to and from control processor 210 are represented by arrows to and from the line entitled “CP 210.” Further, messages to and from server 106 are represented by arrows to and from the line entitled “server 106.” The flow of these messages will be discussed in greater detail in association with FIG. 4. FIG. 4 is a flowchart of one embodiment of the present invention of a method 400 for reducing the number of messages to be processed by control processor 210 in connection with the establishment and termination of a TCP connection.

Referring to FIG. 4, in conjunction with FIG. 3, in step 401, network processor 211 receives a request from client 101 to establish a TCP connection.

In step 402, network processor 211 establishes a TCP connection between load balancer 104 (FIGS. 1 and 2) with client 101. In one embodiment, the TCP connection may be established via a three message handshake between network processor 211 and client 101 as illustrated in FIG. 3. Referring to FIG. 3, the three message handshake, as indicated by box 301, may include a SYN packet issued by client 101 to network processor 211. Network processor 211 may then issue a SYN/ACK packet to client 101. Client 101, in turn, may issue an ACK packet to network processor 211. By offloading the establishment of the TCP connection between client 101 and load balancer 104 to network processor 211 instead of control processor 210, the number of messages to be processed by control processor 210 is reduced.

Returning to FIG. 4, in conjunction with FIG. 3, in step 403, network processor 211 receives a request message, e.g., HTTP request, from client 101. For example, network processor 211 may receive an HTTP request to access a web site maintained by one or more servers 106.

In step 404, network processor 211 bundles the client request received in step 403 and information from the handshake messages involved in establishing the TCP connection (the SYN, SYN/ACK and ACK packets) into a single message. In step 405, network processor 211 transmits the bundled message to control processor 210. By network processor 211 bundling the client request received in step 403 and the handshake messages involved in establishing the TCP connection into a single message, there are fewer messages that need to be processed by control processor 210.

In step 406, control processor 210 identifies the appropriate server 106 in server farm 105 (FIG. 1) to service the client's 101 request using the information extracted from client's 101 request. For example, control processor 210 may extract pertinent information, e.g., source IP address, destination IP address, source TCP port number, destination TCP port number, from the header of client's 101 request or may extract portions of the HTTP portion of the request in order to select the appropriate server 106 in server farm 105 to service the request. The decision may also be affected by the current load or processing activity of the servers 106 in server farm 105.

In step 407, control processor 210 bundles the client's 101 request and a control message into a single message where the control message contains information to enable network processor 211 to create entries in a forwarding table and establish a TCP connection with server 106 selected by control processor 210 in step 406. The entries created in the forwarding table may be for the TCP connection between client 101 and load balancer 104 (created in step 402) as well as the TCP connection between load balancer 104 and server 106 (created in step 409 as described below). By creating these entries in the forwarding table, the future packets from client 101 are forwarded by network processor 211 to server 106 selected by control processor 210 until the TCP connection is terminated. Similarly, by creating these entries in the forwarding table, packets from server 106 selected by control processor 210 will be forwarded by network processor 211 to the correct client 101. It is noted that messages between control processor 210 and network processor 211 that do not involve forwarding any information from a network device may be referred to as “control messages.” Other types of messages, e.g., messages involved in establishing or terminating a TCP connection, requests and responses, may be referred to as “data messages.” Hence, control processor 210 is bundling both control and data information into a single message.

In step 408, control processor 210 transmits the bundled message that includes the client's request and the control message to network processor 211.

In step 409, network processor 211 establishes a TCP connection with server 106 selected by control processor 210 in step 406. In one embodiment, the TCP connection may be established via a three message handshake between network processor 211 and server 106 selected by control processor 210 as illustrated in FIG. 3. Referring to FIG. 3, the three message handshake, as indicated by box 302, may include a SYN packet issued by network processor 211 to server 106 selected by control processor 210. Sever 106 may then issue a SYN/ACK packet to network processor 211. Network processor 211, in turn, may issue an ACK packet to server 106. By offloading the establishment of the TCP connection between load balancer 104 and server 106 to network processor 211 instead of control processor 210, the number of messages to be processed by control processor 210 is reduced.

Returning to FIG. 4, in conjunction with FIG. 3, in step 410, network processor 211 transmits the client's 101 request to server 106 selected by control processor 210.

In step 411, network processor 211 receives a response to the client's 101.: request from server 106 selected by control processor 210. In step 412, network processor 211 performs a table lookup in the forwarding table to determine the appropriate client 101. In one embodiment, the appropriate client 101 may be identified by indexing in the forwarding table using information in the header of the server's 106 response. The indexed entry in the forwarding table may contain a pointer to the appropriate client 101. In step 413, network processor 211 forwards the server's 106 response to the appropriate client 101 identified in the forwarding table. After network processor 211 transmits the server's 106 response to the appropriate client 101, network processor 211, in step 414, receives an acknowledgment from the appropriate client 110. In step 415, network processor 211 performs a table lookup in the forwarding table to identify the appropriate server 106 in sever farm 105 to service the client's 101 response by indexing in the forwarding table using information in the header of the client's 101 response. In step 416, network processor 211 forwards the client's 101 response to the appropriate server 106. The client 101 and the appropriate server 106 may continue to respond to each other's messages, as indicated in steps 411-416, until server 106 terminates the TCP connection as described below.

In step 417, network processor 211 receives a request to terminate the TCP connection by server 106 selected by control processor 210 in step 406. In step 418, network processor 211 facilitates the termination of the TCP connections between load balancer 104 and server 106 (server 106 selected by control processor 210 in step 406) and between load balancer 104 and client 101 (client 101 that issued the request to establish a TCP connection in step 401). In one embodiment, the TCP connection may be terminated via the three message handshake between client 101 and server 106 facilitated by network processor 211 as illustrated in FIG. 3. Referring to FIG. 3, the three message handshake, as indicated by box 303, may include a FIN packet issued by server 106 to network processor 211 which is then forwarded to client 101. Client 101 may then issue a FIN/ACK packet to network processor 211 which is then forwarded to server 106. Server 106, in turn, may issue an ACK packet to network processor 211 which is then forwarded to client 101. By offloading the termination of the TCP connection between client 101 and load balancer 104 and between load balancer 106 and server 106 to network processor 211 instead of control processor 210, the number of messages to be processed by control processor 210 is reduced.

Returning to FIG. 4, in conjunction with FIG. 3, method 400 may include an optional step, step 419, where network processor 211 bundles information regarding a series of closed connections. Information may include statistical data, e.g., number of bytes transmitted in that connection, number of connections established over a particular period of time, as well as information used to identify the data structures stored in RAM 214 (FIG. 2) or disk unit 220 (FIG. 2) in load balancer 104 containing data for the closed connections. Network processor 211 may bundle such information after a particular number of connections have been closed. In step 420, network processor 211 transmits the bundle of information regarding a series of closed connections to control processor 210.

In step 421, control processor 210 extracts the information from the bundled message. For example, control processor 210 may extract the statistical data from the bundled message in order to perform some statistical analysis on the closed connections. In another example, control processor 210 may extract information regarding the data structures stored in RAM 214 (FIG. 2) or disk unit 220 (FIG. 2) in load balancer 104 containing data on the closed connections in order to identify the data structures to be erased thereby freeing up memory space.

By using method 400 to establish and terminate TCP connections, control processor 210 processes at most 3 messages and usually only 2 messages (bundled message received from network processor 211 in step 405, bundled message transmitted by control processor 210 to network processor 211 in step 408 and optionally the bundled message regarding a series of closed connections received from network processor 211 in step 420). Hence, the number of messages processed by control processor 210 in connection with the establishment and termination of TCP connections using method 400 is reduced. Consequently, the performance of control processor 210 and hence the performance of load balancer 104 is improved.

It is noted that method 400 may include other and/or additional steps that, for clarity, are not depicted. It is further noted that method 400 may be executed in a different order presented and that the order presented in the discussion of FIG. 4 is illustrative. It is further noted that certain steps in method 400 may be executed in a substantially simultaneous manner.

Although the system, method and computer program product are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

1. A method for reducing the number of messages to be processed by a control processor in a load balancer comprising the steps of:
receiving a request to establish a TCP connection from a client by a network processor in said load balancer;
establishing said TCP connection with said client via handshake messages between said network processor and said client;
receiving a request message from said client;
bundling said request message and information from said handshake messages involved in establishing said TCP connection by said network processor; and
transmitting said bundled message to said control processor by said network processor.

2. The method as recited in claim 1 further comprising the steps of:
identifying a server in a server farm to service said client's request message by said control processor;
bundling said client's request message and a control message by said control processor; and
transmitting said bundled message comprising said client's request message and said control message to said network processor.

3. The method as recited in claim 2, wherein said server in said server farm is identified using information extracted from said client's request message.

4. The method as recited in claim 2, wherein said control message comprises information used to enable said network processor to create entries in a forwarding table to ensure packets from said client are transmitted to said server and to ensure packets from said server are transmitted to said client.

5. The method as recited in claim 2, wherein said control message comprises information to establish a TCP connection between said load balancer and said server.

6. The method as recited in claim 2 further comprising the steps of:
receiving a request to terminate said TCP connection from said server by said network processor;
facilitating said termination of said connection between said server and said client;
bundling information regarding a series of closed connections by said network processor; and
transmitting said bundled message regarding said series of closed connections to said control processor by said network processor.

7. The method as recited in claim 6 further comprising the step of:
extracting information from said bundled message regarding said series of closed connections by said control processor.

8. A computer program product embodied in a machine readable medium for reducing the number of messages to be processed by a control processor in a load balancer comprising the programming steps of:
receiving a request to establish a TCP connection from a client by a network processor in said load balancer;
establishing said TCP connection with said client via handshake messages between said network processor and said client;
receiving a request message from said client;
bundling said request message and information from said handshake messages involved in establishing said TCP connection by said network processor; and
transmitting said bundled message to said control processor by said network processor.

9. The computer program product as recited in claim 8 further comprising the programming steps of:
identifying a server in a server farm to service said client's request message by said control processor;
bundling said client's request message and a control message by said control processor; and
transmitting said bundled message comprising said client's request message and said control message to said network processor.

10. The computer program product as recited in claim 9, wherein said server in said server farm is identified using information extracted from said client's request message.

11. The computer program product as recited in claim 9, wherein said control message comprises information used to enable said network processor to create entries in a forwarding table to ensure packets from said client are transmitted to said server and to ensure packets from said server are transmitted to said client.

12. The computer program product as recited in claim 9, wherein said control message comprises information to establish a TCP connection between said load balancer and said server.

13. The computer program product as recited in claim 9 further comprising the programming steps of:
receiving a request to terminate said TCP connection from said server by said network processor;
facilitating said termination of said connection between said server and said client;
bundling information regarding a series of closed connections by said network processor; and
transmitting said bundled message regarding said series of closed connections to said control processor by said network processor.

14. The computer program product as recited in claim 13 further comprising the programming step of:
extracting information from said bundled message regarding said series of closed connections by said control processor.

15. A load balancer, comprising:
a network processor, wherein said network processor is configured to process fast path packets;
a control processor coupled to said network processor, wherein said control processor is configured to process slow path packets; and
a memory unit coupled to said control processor and said network processor, wherein said memory unit is operable for storing a computer program for reducing the number of messages to be processed by said control processor;
wherein said network processor, responsive to said computer program, comprises:
circuitry operable for receiving a request to establish a TCP connection from a client;
circuitry operable for establishing said TCP connection with said client via handshake messages between said network processor and said client;
circuitry operable for receiving a request message from said client;
circuitry operable for bundling said request message and information from said handshake messages involved in establishing said TCP connection; and
circuitry operable for transmitting said bundled message to said control processor.

16. The system as recited in claim 15, wherein said control processor, responsive to said computer program, comprises:
circuitry operable for identifying a server in a server farm to service said client's request message;
circuitry operable for bundling said client's request message and a control message; and
circuitry operable for transmitting said bundled message comprising said client's request message and said control message to said network processor.

17. The system as recited in claim 16, wherein said control message comprises information used to enable said network processor to create entries in a forwarding table to ensure packets from said client are transmitted to said server and to ensure packets from said server are transmitted to said client.

18. A load balancer, comprising:
a network processor, wherein said network processor is configured to process fast path packets;
a control processor coupled to said network processor, wherein said control processor is configured to process slow path packets; and
a memory unit coupled to said control processor and said network processor, wherein said memory unit is operable for storing a computer program for reducing the number of messages to be processed by said control processor;
wherein said network processor, responsive to said computer program, comprises:
circuitry operable for receiving a request to establish a TCP connection from a client;
circuitry operable for establishing said TCP connection with said client via handshake messages between said network processor and said client;
circuitry operable for receiving a request message from said client;
circuitry operable for bundling said request message and information from said handshake messages involved in establishing said TCP connection;
circuitry operable for transmitting said bundled message to said control processor;
circuitry operable for receiving a request to terminate said TCP connection from said server;
circuitry operable for facilitating said termination of said connection between said server and said client;
circuitry operable for bundling information regarding a series of closed connections; and
circuitry operable for transmitting said bundled message regarding said series of closed connections to said control processor.

19. The system as recited in claim 18, wherein said control processor comprises:
circuitry operable for extracting information from said bundled message regarding said series of closed connections.
